(19) United States
(12) Patent Application Publication
(10) Pub. No.: US 2011/0117850 A1
(43) Pub. Date: May 19, 2011

(54) Apparatus and Methods for Enabling Smart Portable Device to be Universal Remote Control

(76) Inventors: Hei Tao Fung, Newark, CA (US); Tony K. Mak, San Francisco, CA (US)

(21) Appl. No.: 12/620,603

(22) Filed: Nov. 18, 2009

(51) Int. Cl. H04B 7/005; G08C 19/12

(52) U.S. Cl. 455/41.3; 341/176; 455/68

(57) ABSTRACT

An apparatus comprises a radio frequency (RF) unit, an Infrared (IR) signal unit, and a processing unit that decodes the codes received from the RF unit and feeds them into the IR signal unit. The codes control the home electronic appliances such as TV, VCR, Hi-Fi systems, etc. that can decode IR remote control codes. A smart portable device such as a smart phone is equipped with powerful CPU, touch screen, networking interface, etc. The software application running on the smart portable device can convert the user commands received on the graphical user interface (GUI) into messages that contain the IR remote control codes and communicate the messages over the RF network to the apparatus.

### FIELD OF THE INVENTION

The present invention relates to a universal remote control device. More specifically the present invention relates to making a smart mobile device to be a universal remote control device.

### BACKGROUND

Nowadays many consumer electronic appliances come with their own distinct and proprietary remote controls. Those remote controls have been using infrared (IR) signals to convey remote control codes corresponding to user commands to the electronic appliances, which have IR remote control decoder embedded. An average household may have a number of remote controls for television, DVD player, hi-fi system, set-top box, etc. In order to alleviate the confusion and hassle of handling multiple remote controls, technologies have been developed to integrate the functionality of all remote controls into one universal remote control. Nowadays, the advanced universal remote controls may have touch screen and user-friendly interface.

Meanwhile, the portable computing device technologies have made a leap. There are advanced mobile phones, PDA, etc., collectively referred to as smart portable devices herein, that possess powerful CPU, touch screen, networking interface, etc. Those smart portable devices are capable of communicating over Wi-Fi and Bluetooth networks with other devices. The aforementioned technology advancement makes it feasible to make the smart portable devices a good choice to be advanced universal remote controls. The missing piece is an apparatus that can convert messages from smart portable devices over the Wi-Fi or Bluetooth network to messages representing IR remote control codes decodable by the electronic appliances. The current invention discloses such an apparatus.

### SUMMARY OF THE INVENTION

An apparatus and methods for enabling smart portable devices to be universal remote controls is disclosed. Said apparatus receives data packets over the Bluetooth personal area network (PAN) from a smart portable device, decodes the data packets to generate infrared (IR) remote control codes, and transmits the IR remote control codes as modulated IR signals.

In our preferred embodiment, the smart portable device is capable of communicating to said apparatus over the Bluetooth PAN using Serial Port Profile (SPP). The data packet sent follows a protocol to be disclosed. The protocol data unit (PDU) carries IR remote codes in the payload. The software application running on the smart portable device sends the PDUs via a RFCOMM connection in response to user inputs. Said apparatus comprises a microcontroller. Software running on the microcontroller implements SPP and can receive the PDUs from a RFCOMM connection. Said software further decodes the PDUs received and outputs the IR remote codes to output pins. Said output pins controls the emittance of IR signals on an IR LED.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates an application of the invention disclosed.

FIG. 2 is a diagram of Bluetooth protocol stack.

FIG. 3 illustrates the format of the protocol data unit of our preferred embodiment.

FIG. 4 is a hardware block diagram of one embodiment.

### DETAILED DESCRIPTION OF THE INVENTION

An apparatus and methods for enabling smart portable devices to be universal remote controls is disclosed. Said apparatus receives data packets over the Bluetooth personal area network (PAN) from a smart portable device, decodes the data packets to generate infrared (IR) remote control codes, and transmits the IR remote control codes as modulated IR signals.

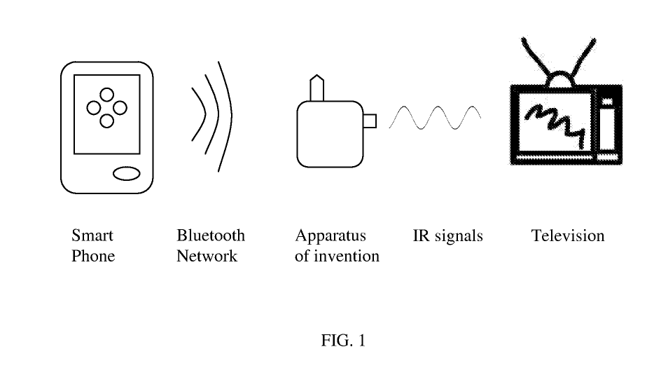

In our preferred embodiment, the smart portable device is capable of communicating to said apparatus over the Bluetooth PAN using Serial Port Profile (SPP). Refer to FIG. 1. The smart portable device is running a software application that takes user inputs, translates user inputs into remote control codes compatible to the electronic appliance to be controlled, and conveys the remote control codes using a protocol to be disclosed to said apparatus. Said protocol is implemented over the RFCOMM protocol. Said protocol shall be referred to as Universal Remote Control Protocol (URCP) herein. Said apparatus comprises a Bluetooth receiver, a microcontroller as Bluetooth decoder, and an IR signal generating component. Said microcontroller runs software that understands SPP and can receive the URCP packet data unit (PDU) from RFCOMM connection. Said microcontroller decodes URCP PDUs to retrieve the IR remote control codes. Said microcontroller drives a plurality of output interfaces according to the IR remote control codes and information in the URCP PDUs. Said output interfaces comprise a serial port and some channel select pins. The IR signal generating component comprises one or more IR transmission units. The channel select pins select the IR transmission unit to use. The IR signals reach the electronic appliance that contains the IR remote control decoder and reacts to the IR remote control codes representing the user inputs.

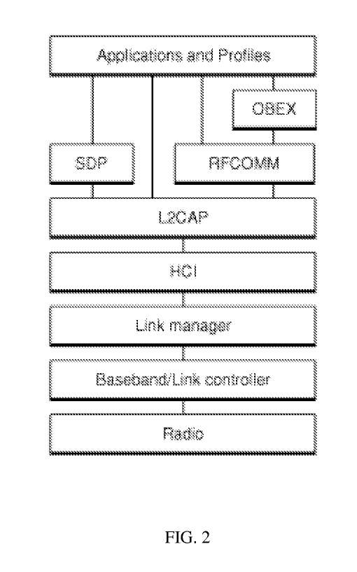

The Bluetooth protocol stack comprises RFCOMM protocol which simulates a serial connection. Refer to FIG. 2. URCP is built over RFCOMM and uses RFCOMM connection. RFCOMM is one of the components in SPP.

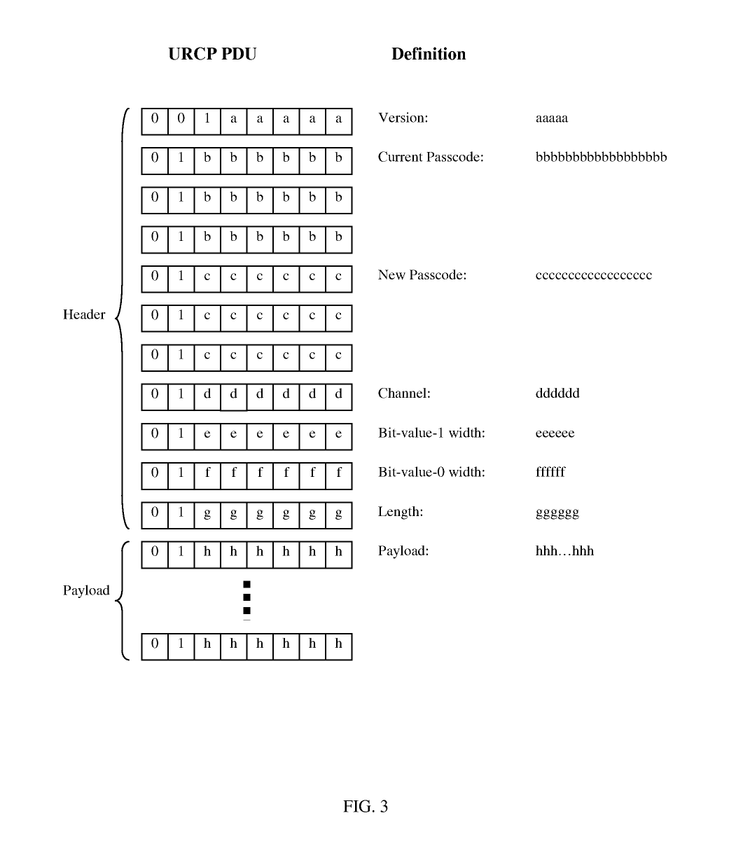

URCP PDU format is shown in FIG. 3. Any PDU begins with a header. The most significant three bits of the first byte of the header are always ‘001’ The remaining five bits are the version field. The first two bits of the other bytes in the header and the bytes in the payload are always ‘01’ The remaining six bits carry the specific information representing the user inputs. Therefore, the beginning of a URCP PDU is easy to identify. The version field identifies the URCP version. The current passcode field is used as a password for accessing an instance of said apparatus. The new passcode field carries the replacement value of the passcode stored on said apparatus. The channel field indicates which IR transmission unit to output the decoded IR remote control code. The bit-value-1 width field carries the duration of bit value 1 in microseconds. The bit-value-0 width field carries the duration of the bit value 0 in microseconds. The length field indicates the number of bytes of payload to follow. The payload field is variable in size and comprises zero or more bytes. The payload field carries the sequence of bits of an IR remote control code corresponding to the user input. An IR remote control code is divided into groups of 6 bits. Each payload byte carries a 6-bit group.

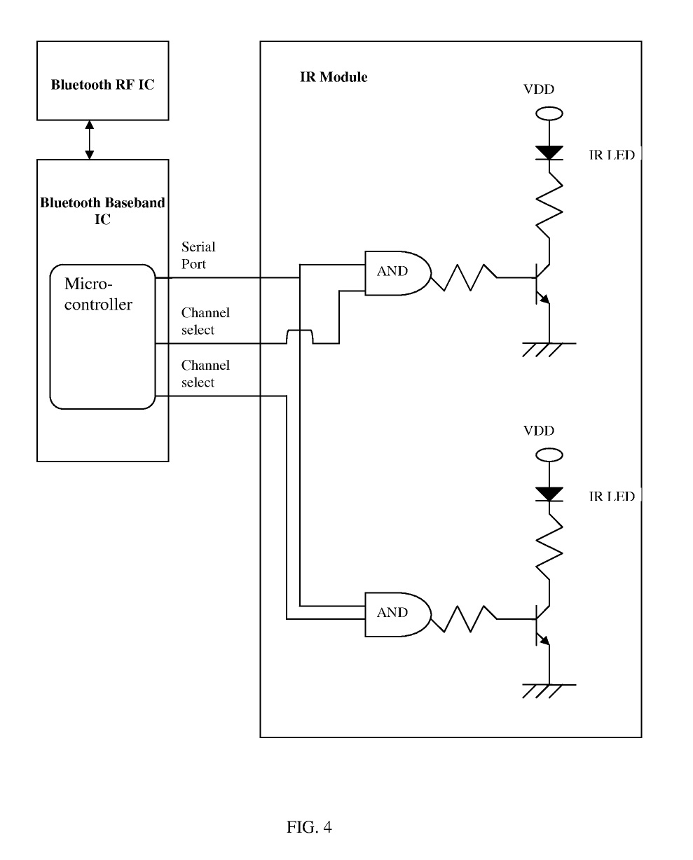

FIG. 4 shows one embodiment of the invention. Said apparatus in the embodiment comprises a Bluetooth RF integrated circuit (IC) module, a Bluetooth baseband decoder IC module, and an IR module. The baseband decoder IC module comprises a microcontroller to handle the SPP profile and the URCP disclosed herein. The IR module comprises a plurality of transmission units. The microcontroller selects one transmission unit specified by the channel field, and the microcontroller drives the serial port to low or high according to the bit value of the decoded remote control code. Each transmission unit in the IR module comprises an IR LED and a transistor as an on/off switch. The serial port controls the on/off switch. When serial port is driven to high, current flows through the IR LED and IR signal is emitted. When serial port is driven to low, no current can flow through the IR LED and no IR signal is emitted. The microcontroller modulates the decoded remote control code over a carrier frequency, for example, 40 KHz, to minimize interference from other IR sources. In other words, for a decoded bit value 0, the microcontroller triggers no IR signal emittance from said apparatus for a duration specified by the bit-value-0 width field; for a decoded bit value 1, the microcontroller triggers a burst of ones, i.e., IR signal emittance, and zeroes, i.e., no IR signal emittance, at the modulation frequency for a duration specified by the bit-value-1 width field.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. An apparatus to enable smart portable device to control a plurality of electronic appliances, comprising: means for receiving protocol data units from smart portable device; means for decoding said protocol data units to retrieve IR remote control codes; and means for transmitting said IR remote control codes.

2. The apparatus of claim 1, wherein said protocol data units are received via a Bluetooth network.

3. The apparatus of claim 1, wherein said means for decoding said protocol data units implements the Bluetooth Serial Port Profile and decodes said protocol data units received from a RFCOMM connection to retrieve IR remote control codes.

4. The apparatus of claim 1, wherein said means for decoding said protocol data units drives one or more output interfaces according to the retrieved IR remote control codes and the information in said protocol data units.

5. The apparatus of claim 4, wherein said information in said protocol data units comprises version field and header starting byte identifier.

6. The apparatus of claim 4, wherein said information in said protocol data units further comprises current passcode field and new passcode field for access control.

7. The apparatus of claim 4, wherein said information in said protocol data units further comprises bit-value-1 width field and bit-value-0 width field for controlling the duration of modulated IR signals.

8. The apparatus of claim 4, wherein said means for transmitting said IR remote control codes comprises one or more transmission units, where each said transmission unit comprises: an IR LED, and an on/off switch controlled by said output interfaces.

9. The apparatus of claim 8, wherein said information in said protocol data units further comprises channel field for selecting one of said transmission units.

10. A method for enabling smart portable device to control a plurality of electronic appliances, comprising: receiving protocol data units from smart portable device; decoding said protocol data units to retrieve IR remote control codes; and transmitting said IR remote control codes.

11. The method of claim 10, wherein said protocol data units are received via a Bluetooth network.

12. The method of claim 10, further comprising implementing the Bluetooth Serial Port Profile and decoding said protocol data units received from a RFCOMM connection to retrieve IR remote control codes.

13. The method of claim 10, further comprising driving one or more output interfaces according to the retrieved IR remote control codes and the information in said protocol data units.

14. The method of claim 13, wherein said information in said protocol data units comprises version field and header starting byte identifier.

15. The method of claim 13, wherein said information in said protocol data units further comprises current passcode field and new passcode field for access control.

16. The method of claim 13, wherein said information in said protocol data units further comprises bit-value-1 width field and bit-value-0 width field for controlling the duration of modulated IR signals.

17. The method of claim 13, wherein said information in said protocol data units further comprises channel field for selecting one of a plurality of transmission units, where each said transmission unit comprises: an IR LED, and an on/off switch controlled by said output interfaces.

18. A universal remote control system, comprising: a smart portable device that converts user inputs into IR remote control codes specific to the electronic appliance to be controlled and transmits protocol data units that encode said IR remote control codes over a wireless network; and an electronic device that receives said protocol data units via said wireless network and transmits said IR remote control codes retrieved from said protocol data units.

19. The universal remote control system of claim 18, wherein said smart portable device and said electronic device communicate over a Bluetooth network.

20. The universal remote control system of claim 18, wherein said smart portable device and said electronic device implement the Bluetooth Serial Port Profile and send protocol data units over a RFCOMM connection.
